(19) United States
(12) Patent Application Publication
(10) Pub. No.: US 2004/0179904 A1
(43) Pub. Date: Sep. 16, 2004

(54) Speedway burrs

(76) Inventor: Qing Zhou, Shanghai (CN)

Correspondence Address: Qianghua Zhou, 1046 Canary Lane, Onalaska, WI, 54650, US

(21) Appl. No.: 10/384,891

(22) Filed: Mar. 10, 2003

(51) Int. Cl. B23C 5/10

(52) U.S. Cl. 407/54

(57) ABSTRACT

The invention is a rotary cutter having both coarse teeth and fine teeth. The coarse tooth gives great cutting and removal of the dust fast, then the fine tooth can finish the surface smoothly. The invention improves cutting speed and has smooth surface finish. The invention can apply to different head shapes, such as ball, cylinder, cone etc.

### BACKGROUND OF THE INVENTION

Rotary cutters are common hardware tools. They are used on various applications. Currently, rotary cutters have a single type tooth, which may be a coarse tooth, standard tooth or fine tooth. Different tooth types have their advantages and disadvantages:

A coarse tooth cutter has large teeth. It can cut fast and has strong cutting power. However, the surface finish is rough.

A fine tooth cutter has small teeth. It has smooth surface finish. However, it cut slowly.

The standard tooth cutter has medium size teeth. It is a compromise of the above two.

Today, no rotary cutter has both strong removal capability and smooth surface finish. The invention directly addresses this area.

### DESCRIPTION OF THE DRAWING

FIG. 1: the side view of the invention

FIG. 2: the bottom view of the invention

FIG. 3: the top view of the invention

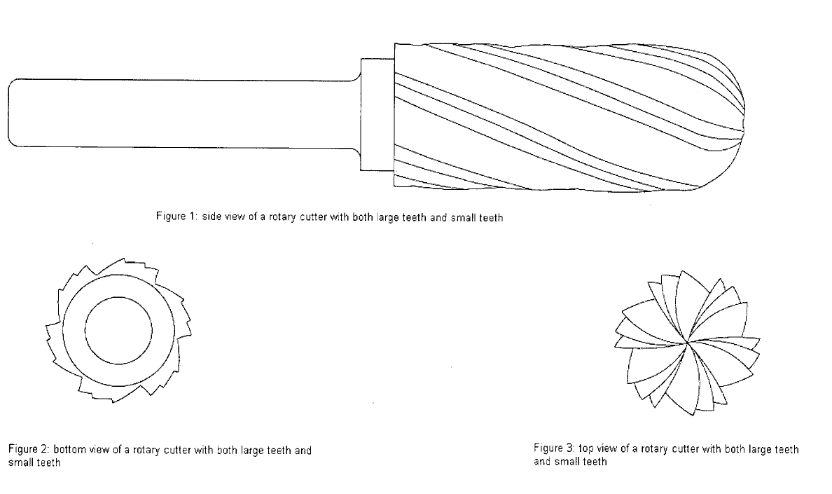

### DESCRIPTION OF THE INVENTION

The invention is a rotary cutter having both coarse teeth and fine teeth. As shown in Figure, the invention alternates smooth tooth and coarse tooth on both top and side of cutter head. The coarse tooth gives great cutting and removal of the dust fast, then the fine tooth can finish the surface smoothly. The invention improves cutting speed and has smooth surface finish.

The invention can apply to different head shapes, such as ball, cylinder, cone etc. It uses cylinder head cutter with a ball top as an example in the drawing.

The large tooth alternates with the small tooth in different ratio. The ratio is 1:3 as an example in the drawing.

The invention can be made of high speed steel, Tungsten carbide, or other suitable materials.

What is claimed is:

1. A rotary cutter with a head having teeth of different sizes. The large teeth alternate with the small teeth on top or/and side of the head.
